(19) United States
(12) Patent Application Publication
(10) Pub. No.: US 2019/0068635 A1
(43) Pub. Date: Feb. 28, 2019

(54) DATA PROCESSING METHOD, APPARATUS, AND SYSTEM

(71) Applicant: ALIBABA GROUP HOLDING LIMITED, George Town (KY)

(72) Inventors: Jianyong GE, Hangzhou (CN); Lele MA, Hangzhou (CN); Yangyang SONG, Hangzhou (CN)

(21) Appl. No.: 16/172,663

(22) Filed: Oct. 26, 2018

Related U.S. Application Data
(63) Continuation of application No. PCT/CN2017/082174, filed on Apr. 27, 2017.

(30) Foreign Application Priority Data
Jun. 5, 2016 (CN) 201610298594.8

(51) Int. Cl. H04L 29/06; G06F 17/30

(52) U.S. Cl. CPC H04L 63/1458; H04L 29/06; G06F 17/30861; H04L 65/104

(57) ABSTRACT

The present application provides data processing methods and apparatuses. A data processing apparatus can include: a communication interface; a memory storing a set of instructions; and at least one processor configured to execute the set of instructions to cause the apparatus to perform: receiving a target data packet sent by a network device; cleaning the target data packet; and sending the cleaned target data packet to a target website server.

### CROSS REFERENCE TO RELATED APPLICATION

The disclosure claims the benefits of priority to International application number PCT/CN2017/082174, filed Apr. 27, 2017, and Chinese application number 201610298594.8, filed Jun. 5, 2016, both of which are incorporated herein by reference in their entireties.

### BACKGROUND

With the continuous progress of science and technology, the Internet field is developing rapidly. Users usually access various websites by using the Internet. FIG. 1 shows a network system for a user to access a website. Referring to FIG. 1, the network system includes: a terminal 100 configured to serve a user, a network device 200, and a plurality of website servers 400 provided with security gateways 300. A data packet sent by terminal 100 can reach network device 200, and network device 200 can then forward the data packet to website server 400 provided with a security gateway 300.

Because network attacks are on the rise, terminals accessing website server 400 include normal terminals and attacking terminals. Therefore, there may be normal packets sent by the normal terminals and attack packets sent by the attacking terminals among the data packets received by target website server 400. To protect target website server 400 from being attacked, security network 300 is used to process the data packets, such that only normal packets are allowed to be sent to website server 400.

Currently, the dominating network attack is a Distributed Denial of Service (DDoS) attack. DDoS attacks can send a large quantity of data packets to a website server 400 by using a large number of zombie computers, such that website server 400 crashes as it has no resource to process the large quantity of data packets. Therefore, in the network system, when an attacking device intends to launches a DDoS attack to website server 400, a large quantity of data packets sent to the security gateway 300 are bound to be gathered on network device 200.

However, the Internet bandwidth between network device 200 corresponding to website server 400 and security network 300 can only bear a normal quantity of data packets. The large quantity of data packets generated from the DDoS attack launched by the attacking terminal have greatly exceeded the transmission capability of the Internet bandwidth. Therefore, a large quantity of data packets can neither be transmitted to security gateway 300 nor processed by security gateway 300.

Therefore, when the attacking device launches a DDoS attack, the current network system cannot process the DDoS attack. So, a novel network system is now required to solve the problem of a DDoS attack launched by an attacking device to a website server without changing the Internet bandwidth between a network device and a security gateway.

### SUMMARY OF THE DISCLOSURE

The present application provides a data processing method, apparatus and system. The present application can solve the problem of a DDoS attack launched by an attacking device to a website server without changing the Internet bandwidth between a network device and a security gateway.

Embodiments of the application provide a data processing method. The method can include: receiving a target data packet sent by a network device; cleaning the target data packet; and sending the cleaned target data packet to a target website server.

Embodiments of the application also provide a data processing method. The method can include: receiving a target data packet sent by a terminal; and forwarding the target data packet to a cleaning system.

Embodiments of the application further provide a data processing apparatus. The apparatus can include: a communication interface; a memory storing a set of instructions; and at least one processor configured to execute the set of instructions to cause the apparatus to perform: receiving a target data packet sent by a network device; cleaning the target data packet; and sending the cleaned target data packet to a target website server.

Embodiments of the application also provide a data processing apparatus. The apparatus can include: a communication interface; a memory storing a set of instructions; and at least one processor configured to execute the set of instructions to cause the apparatus to perform: receiving a target data packet sent by a terminal; and forwarding the target data packet to a cleaning system.

### BRIEF DESCRIPTION OF THE DRAWINGS

To describe the technical solutions in the embodiments of the present application or the prior art more clearly, the accompanying drawings required for describing the embodiments or the prior art are briefly introduced below. It is apparent that the accompanying drawings described in the following are merely some embodiments of the present application, and those of ordinary skill in the art may still derive other drawings from these accompanying drawings without creative efforts.

FIG. 1 is a schematic structural diagram of a conventional data processing system.

FIG. 2 is a schematic structural diagram of an exemplary data processing system, according to some embodiments of the present application.

FIG. 3 is a flowchart of an exemplary data processing method according to some embodiments of the present application.

FIG. 4 is a flowchart of another exemplary data processing method according to some embodiments of the present application.

FIG. 5 is a flowchart of another exemplary data processing method according to some embodiments of the present application.

FIG. 6 is a flowchart of another exemplary data processing method according to some embodiments of the present application.

FIG. 7 is a flowchart of another exemplary data processing method according to some embodiments of the present application.

FIG. 8 is a flowchart of another exemplary data processing method according to some embodiments of the present application.

FIG. 9 is a flowchart of another exemplary data processing method according to some embodiments of the present application.

FIG. 10 is a flowchart of another exemplary data processing method according to some embodiments of the present application.

FIG. 11 is a schematic structural diagram of an exemplary data processing apparatus according to some embodiments of the present application.

FIG. 12 is a schematic structural diagram of another exemplary data processing apparatus according to some embodiments of the present application.

FIG. 13 is a schematic structural diagram of another exemplary data processing apparatus according to some embodiments of the present application.

FIG. 14 is a schematic structural diagram of another exemplary data processing apparatus according to some embodiments of the present application.

FIG. 15 is a schematic structural diagram of another exemplary data processing apparatus according to some embodiments of the present application.

FIG. 16 is a schematic structural diagram of another exemplary data processing apparatus according to some embodiments of the present application.

FIG. 17 is a schematic structural diagram of another exemplary data processing apparatus according to some embodiments of the present application.

### DETAILED DESCRIPTION

The technical solutions in embodiments of the present application will be described clearly and completely with reference to the accompanying drawings in the embodiments of the present application. Apparently, the described embodiments are merely some rather than all of the embodiments of the present application. Based on the embodiments of the present application, all other embodiments derived by those of ordinary skill in the art without any creative effort shall all fall within the protection scope of the present application.

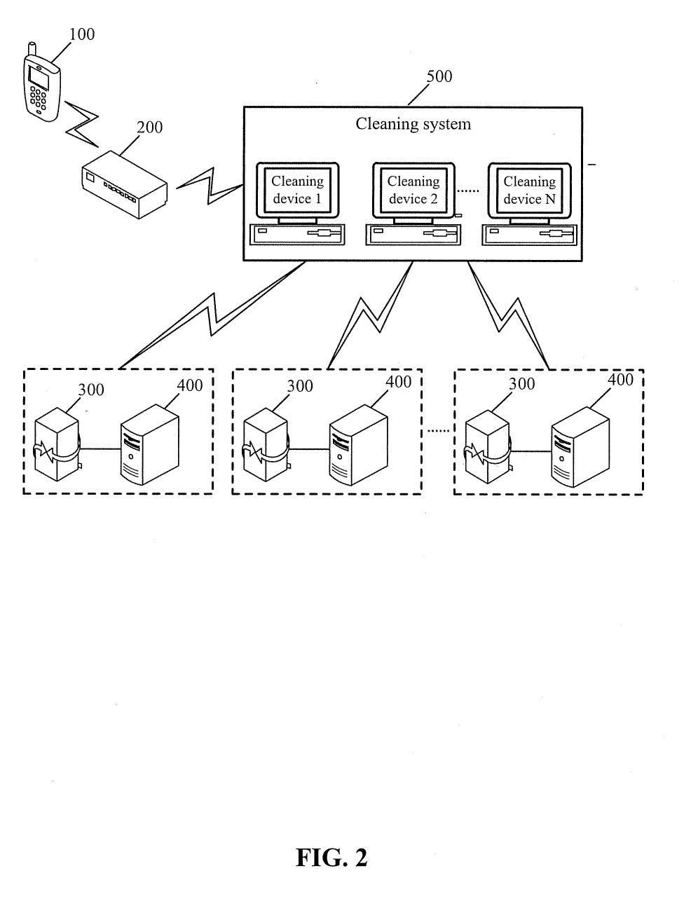

A data processing system is introduced first to illustrate an application scenario of the present application. As shown in FIG. 2, the data processing system includes: a terminal 100, a network device 200 connected to the terminal 100, a cleaning system 500 connected to network device 200, and a plurality of website servers 400 each provided with a security gateway 300 and connected to cleaning system 500. Network device 200 can be a device that can be connected to the Internet, such as a gateway and a router. Cleaning system 500 includes one or more cleaning devices, such as a cleaning device 1, a cleaning device 2, . . . , and a cleaning device N, wherein N is a non-zero natural number. A cleaning device can be a network device provided with a software program that cleans attacking packets.

Cleaning system 500 can be configured to receive a target data packet sent by the network device, clean the target data packet, and send a normal packet after the cleaning to a target website server. A data packet can be a data unit exchanged and transmitted in a network. In other words, the data packet is a data block being sent by a site at a time. The data packet includes full data information to be sent. The data packet can have an inconsistent, unlimited, and variable length. A normal packet can be a data packet that is sent by a normal terminal and will not cause a network attack to a receiver.

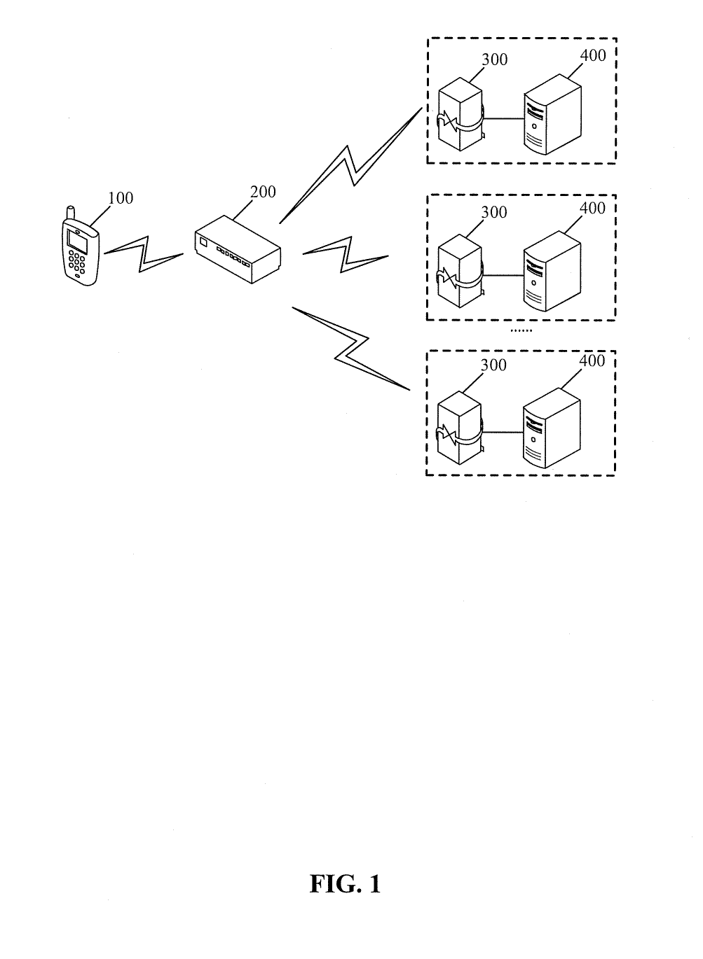

For ease of illustration, a network link between network device 200 and security gateway 300 in FIG. 1 is referred to as a first network link, and a network link between network device 200 and cleaning system 500 in FIG. 2 is referred to as a second network link.

The Internet bandwidth (e.g., 1 gigabytes (GB)) of the first network link purchased by e.g., an enterprise is narrow, and is only sufficient for a normal quantity of data packets to pass through but insufficient for a large quantity of data packets to pass through during a DDoS attack. Cleaning system 500 can be configured to perform DDoS cleaning, and thus the Internet bandwidth purchased by the enterprise corresponding to the cleaning system 500 can be wide (e.g., 100 GB). Therefore, the bandwidth is sufficient for a large quantity of data packets to pass through during a DDoS attack.

The cleaning system is configured to receive a target data packet sent by the network device, clean the target data packet, and send a normal packet after the cleaning to a target website server.

After cleaning system 500 is added, the data packets on network device 200 can be transmitted to cleaning system 500 through the second network link instead of being directly transmitted to security gateway 300 through the first network link. The data packets can be cleaned by cleaning system 500 to obtain normal packets. The normal packets can be then forwarded to security gateway 300, and transmitted to website server 400 by security gateway 300.

Therefore, a large quantity of data packets generated by an attacking terminal do not pass through the first network link, but pass through the second network link to reach cleaning system 500. Therefore, a large quantity of data packets can be cleaned before reaching cleaning system 500, such that normal packets after the cleaning are sent to website server 400 provided with security gateway 300.

The data processing system includes a plurality of website servers each including a security gateway. The processing procedure of the present application is consistent for each website server including a security gateway, and, therefore, the present application is introduced in detail merely by using a target website server including a security gateway as an example. Processing procedures of other website servers each including a security gateway can be obtained with reference to the processing procedure of the target website server including a security gateway.

A new correspondence of a target domain name can be stored in the network device.

The cleaning system includes one or more cleaning devices to provide data packet cleaning services for a plurality of website servers. The cleaning system can select a cleaning device randomly from the one or more cleaning devices and use the selected cleaning device as a target cleaning device that replaces the security gateway to perform DDoS cleaning. The network device can store a correspondence between a domain name of each website server and an IP address. The correspondence can decide the direction of data packets after the Internet performs domain name resolution.

Using the target website server as an example, the network device stores a correspondence between a target domain name of the target website server and a target IP address of the target website server. As such, after receiving a data packet including the target domain name, the network device can directly send the data packet to a target website server provided with a security gateway and corresponding to the target IP address.

However, in order to direct a data packet to the second network link between the network device and the cleaning system instead of the first network link between the network device and the security gateway in the presence of a DDoS attack, a new correspondence can be stored in the network device. The new correspondence can include a correspondence relationship between the target domain name and a cleaning IP address of a target cleaning device in the cleaning system. As such, when there is a DDoS attack, the network device will not send a data packet including the target domain name to the security gateway after receiving the data packet but send the data packet to the target cleaning device.

The correspondence between the target domain name and the target IP address can be added in the target cleaning device.

The target cleaning device processes the data packet including the target domain name after receiving the data packet, so as to obtain a normal packet. The correspondence between the target domain name and the target IP address can be stored in the target cleaning device, so that the target cleaning device can determine a final direction of the normal packet. As such, after obtaining the normal packet, the target cleaning device can forward the normal packet to the target website server corresponding to the target IP address.

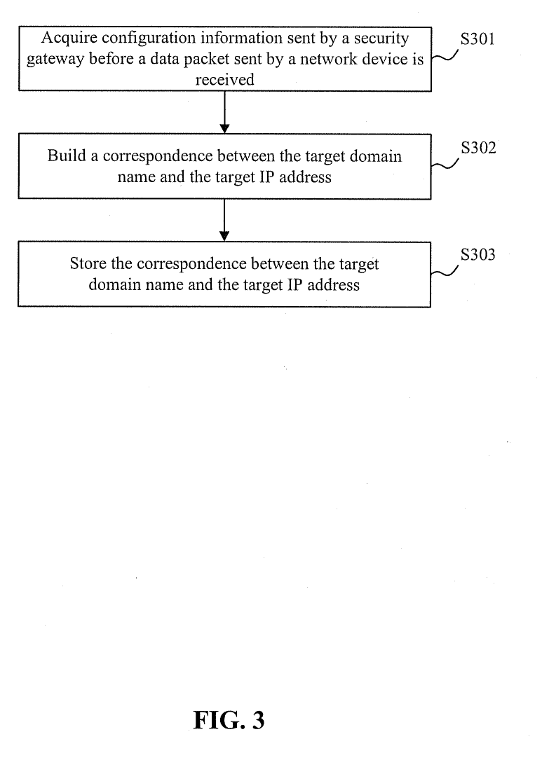

As shown in FIG. 3, the step of adding the correspondence between the target domain name and the target IP address in the target cleaning device may further include steps S301, S302, and S303.

In step S301, configuration information sent by the security gateway can be acquired before the data packet sent by the network device is received. The configuration information can include the target domain name and the target IP address of the target website server. A first application programming interface (API) can be placed between the cleaning system and the security gateway to facilitate communication between the cleaning system and the security gateway. The security gateway can send the configuration information to the target cleaning device of the cleaning system through the first API. The configuration information can include the target domain name and the target IP address of the target website server.

In step S302, a correspondence between the target domain name and the target IP address can be built. After receiving the target domain name and the target IP address of the target website server, the target cleaning device can construct a correspondence between the target domain name and the target IP address.

In step S303, the correspondence between the target domain name and the target IP address can be stored. After the correspondence between the target domain name and the target IP address is constructed, the correspondence between the target domain name and the target IP address can stored, so as to be used subsequently when the normal packet is forwarded.

A cleaning IP address of the target cleaning device can be stored in the security gateway.

After the cleaning system determines the target cleaning device for replacing the security gateway, the target cleaning device can send a cleaning IP address to the security gateway. The security gateway can receive and store the cleaning IP address of the target cleaning device, so as to be used subsequently when the security gateway sends a feedback packet to the target cleaning device.

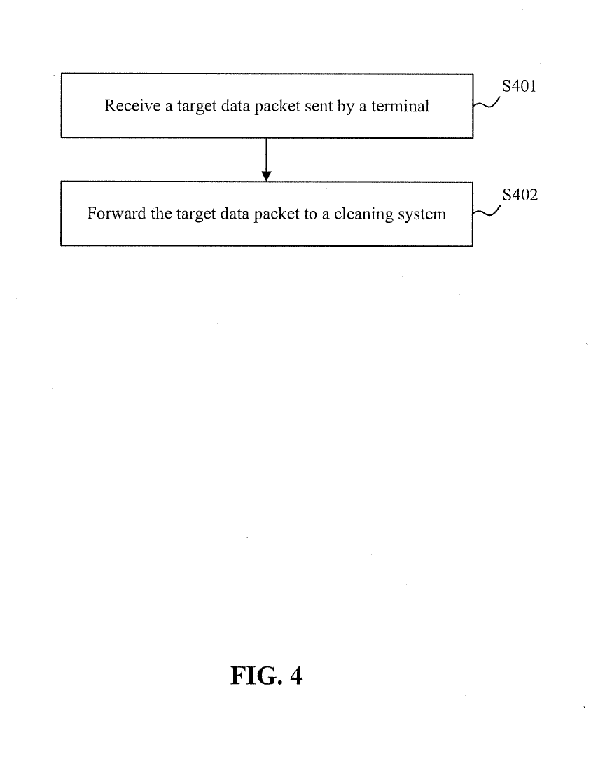

The detailed working process of the present application will be introduced after the preparation process is introduced. As shown in FIG. 4, a data processing method according to embodiments of the application can be applied to the network device of the data processing system shown in FIG. 2. The data processing method can include steps S401 and S402.

In step S401, a target data packet sent by a terminal can be received. The target data packet includes a target domain name. The terminal can send the data packet to a target website server. Therefore, the data packet can include a target domain name of the target website server. Data packets sent to the target website server by all terminals may pass through the network device, and, therefore, the network device can receive data packets including target domain names.

In step S402, the target data packet can be forwarded to a cleaning system.

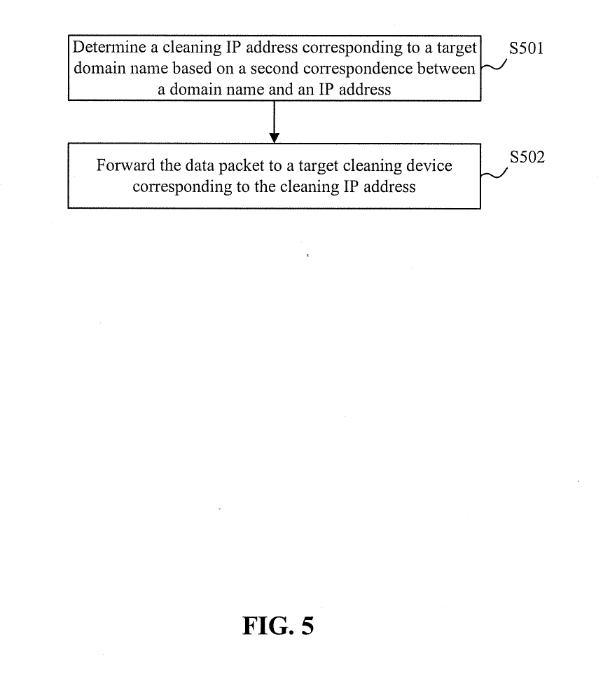

As shown in FIG. 5, this step specifically includes steps S501 and S502.

In step S501, a cleaning IP address corresponding to the target domain name can be determined based on a second correspondence between a domain name and an IP address. The network device stores a correspondence between the target domain name and the cleaning IP address, and the cleaning IP address is an IP address of a target cleaning device in the cleaning system. As discussed above, the network device can store a correspondence between the target domain name and the cleaning IP address of the target cleaning device. Therefore, in this step, a network device can search the second correspondence between the domain name and the IP address according to the target domain name, and determine the cleaning IP address corresponding to the target domain name.

In step S502, the data packet can be forwarded to a target cleaning device corresponding to the cleaning IP address. After the data packet is cleaned by the target cleaning device and a normal packet after the cleaning is obtained, the normal packet can be sent to a target website server corresponding to a target IP address according to a pre-stored correspondence between the target domain name and the target IP address.

The network device can forward the data packet including the target domain to a target cleaning device corresponding to the cleaning IP address in the cleaning system according to the cleaning IP address corresponding to the target domain name. The data packet can be further processed by the target cleaning device.

The network device can store the correspondence between the target domain name and the cleaning IP address. Therefore, when the network device detects a DDoS attack, the network device can change the network link through which the data packet passes, such that the data packet can pass through the second network link instead of the first network link.

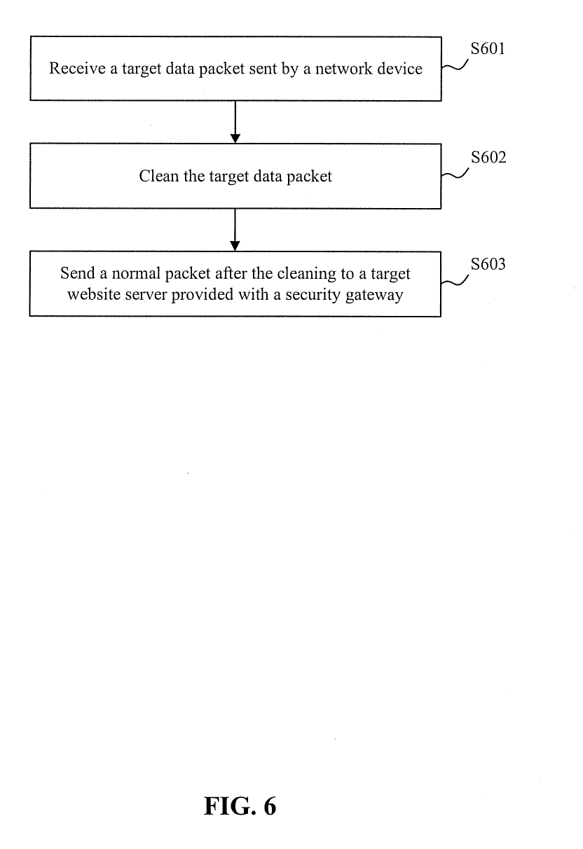

As shown in FIG. 6, a data processing method according to embodiments of the present application is provided and is applied to the cleaning system of the data processing system shown in FIG. 2. The method specifically includes steps S601, S602, and S603.

In step S601, a target data packet sent by a network device can be received. Different cleaning devices may have different IP addresses. The target cleaning device corresponding to the cleaning IP address in the cleaning system can receive the data packet sent by the network device.

In step S602, the target data packet can be cleaned. A cleaning strategy can be pre-stored in the target cleaning device, and the target cleaning device performs cleaning according to the cleaning strategy. By cleaning, attacking packets can be filtered in the data packets to retain normal packets. An attacking packet can be a data packet that is sent by an attacking terminal and will cause a network attack to a receiver.

In step S603, a normal packet after the cleaning can be sent to a target website server provided with a security gateway.

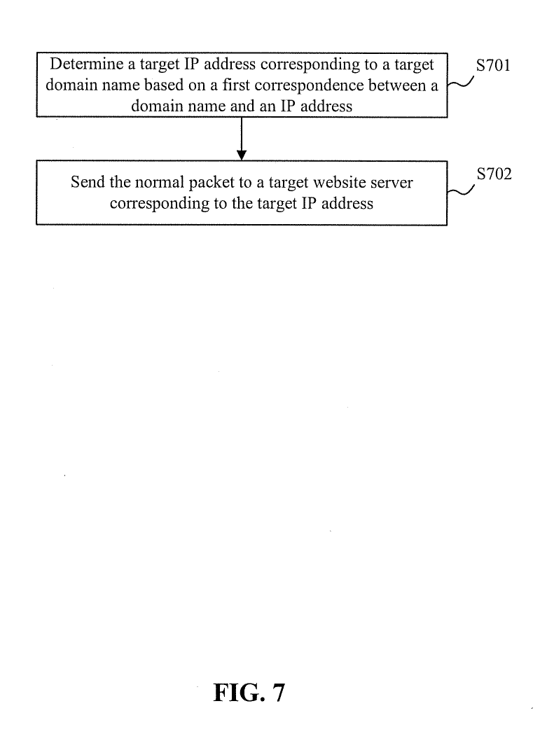

As shown in FIG. 7, step S603 can further include steps S701 and S702.

In step S701, a target IP address corresponding to the target domain name can be determined based on a first correspondence between a domain name and an IP address. The target domain name is included in the target data packet. As discussed above, the correspondence between the target domain name and the target IP address of the target website server can be stored in the target cleaning device.

In step S702, the normal packet can be sent to a target website server corresponding to the target IP address. The data packet sent by the terminal is intended to be sent to the target website server. Therefore, after obtaining the normal data packet, the target cleaning device can send the normal packet to the target website server corresponding to the target IP address according to the correspondence between the target domain name and the target IP address.

A data processing system according to embodiments of the present application can include a cleaning system. Therefore, a large quantity of data packets accessing a target website server may no longer pass through a first network link between a network device and a security gateway, but flow through a second network link between the network device and the cleaning system. The Internet bandwidth of the second network link can be far greater than that of the first network link. Therefore, the cleaning system can handle the large quantity of data packets. Then, the cleaning device can forward normal packets after the cleaning to a target website server.

Therefore, the present application can solve the problem of a DDoS attack launched by an attacking device to a target website server without changing the Internet bandwidth between a network device and a security gateway.

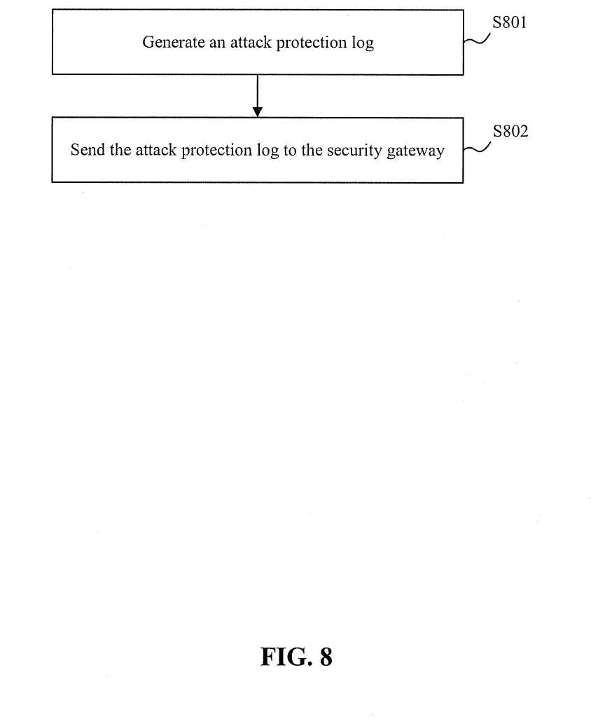

The target cleaning device can further perform a data processing method such that the security gateway of the target network server understands attack information conveniently. As shown in FIG. 8, the process specifically includes the following steps:

In step S801, an attack protection log can be generated. The protection log can include attack time of attacking packets and a data volume of the attacking packets. After the target cleaning device cleans the data packets, some of the attacking packets can be filtered out. An attack protection log can be generated according to information such as the attack time of the attacking packets, a number of attacks of the attacking packets, and types of the attacking packets.

In step S802, the attack protection log can be sent to the security gateway.

A second API can be placed between the target cleaning device and the security gateway to facilitate transmission of the attack protection log between the target cleaning device and the security gateway. The target cleaning device can send the attack protection log to the security gateway through the second API.

After receiving the attack protection log, the security gateway can display the attack protection log, such that a technician who controls the security gateway can understand related information of attacking packets that attack the target website server, and then can make corresponding bug fixes or program improvement.

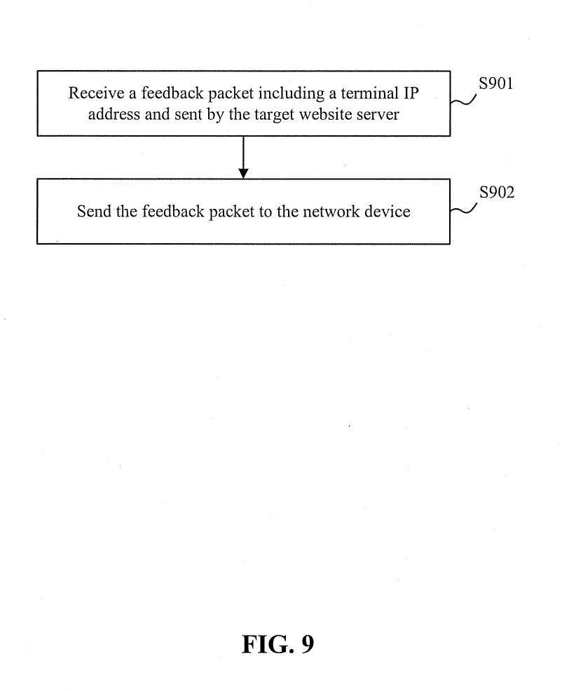

It can be understood that the target cleaning device can further perform a process of sending a feedback packet. As shown in FIG. 9, the process can includes steps S901 and S902.

In step S901, a feedback packet including a terminal IP address and sent by the target website server can be received. The feedback packet is obtained after the target website server processes the data packet.

In embodiments shown in FIG. 6, after receiving the normal packet, the target website server can process the normal packet and generate a feedback packet. It can be understood that, among quintuple information in the normal packet, a source address is the terminal IP address, and a destination address is the target IP address of the target website server. During generation of the feedback packet, the sending direction can be changed. Therefore, among quintuple information in the feedback packet, a source address can be the target IP address of the target website server, and a destination address can be the terminal IP address.

As discussed above, the security gateway can store the cleaning IP address of the target cleaning device. Therefore, the feedback packet can be sent to the target cleaning device corresponding to the cleaning IP address.

In step S902, the feedback packet is sent to the network device. The target cleaning device can send the feedback packet to the network device based on the terminal IP address carried in the feedback packet.

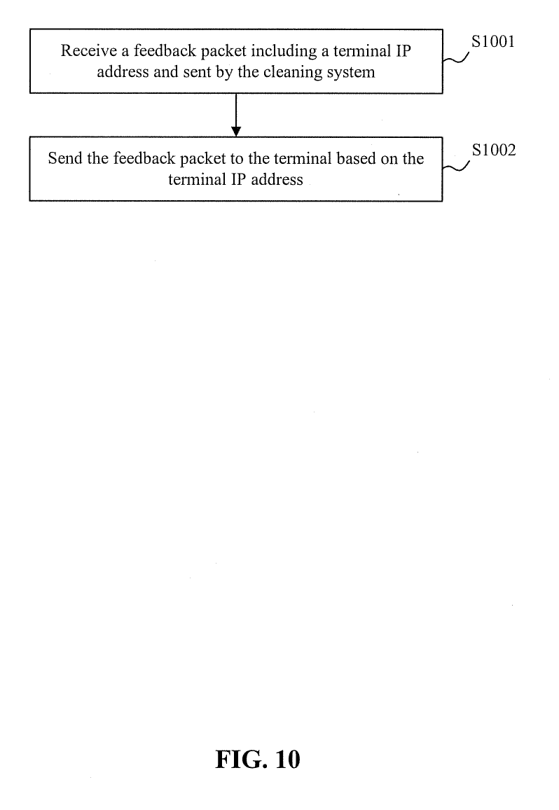

A processing procedure of the network device after receiving the feedback packet will be described. As shown in FIG. 10, the process can include steps S1001 and S1002.

In step S1001, a feedback packet including a terminal IP address and sent by the cleaning system can be received. The feedback packet can be obtained after the target website server processes the data packet.

In step S1002, the feedback packet can be sent to the terminal based on the terminal IP address.

After receiving the feedback packet, the network device can send the feedback packet to the terminal based on the terminal IP address, so as to implement a data exchange process between the terminal and the target website server.

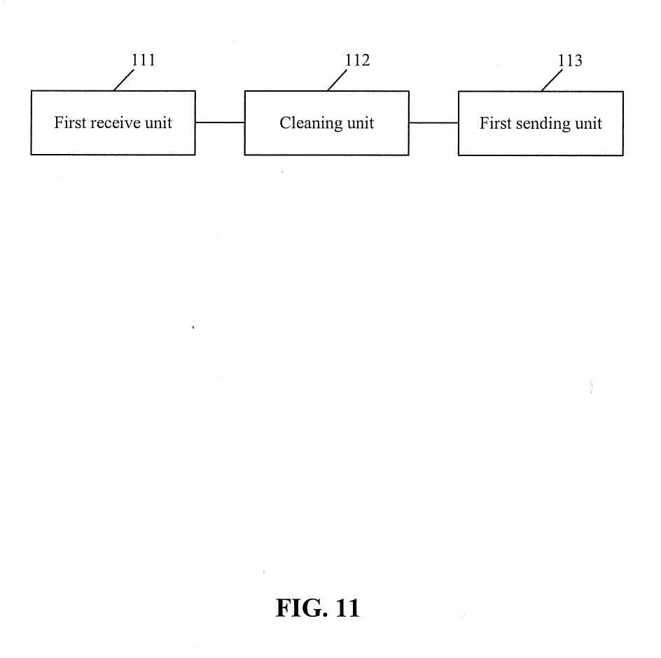

As shown in FIG. 11, embodiments of the application provide a data processing apparatus, which can be applied to a cleaning system of a data processing system. The apparatus can include: a first receiving unit 111, a cleaning unit 112, and a first sending unit 113.

First receiving unit 111 can be configured to receive a target data packet sent by a network device, wherein the network device receives the target data packet sent by a terminal; and forwards the target data packet to a cleaning system.

Cleaning unit 112 can be configured to clean the target data packet.

First sending unit 113 can be configured to send a normal packet after the cleaning to a target website server provided with a security gateway.

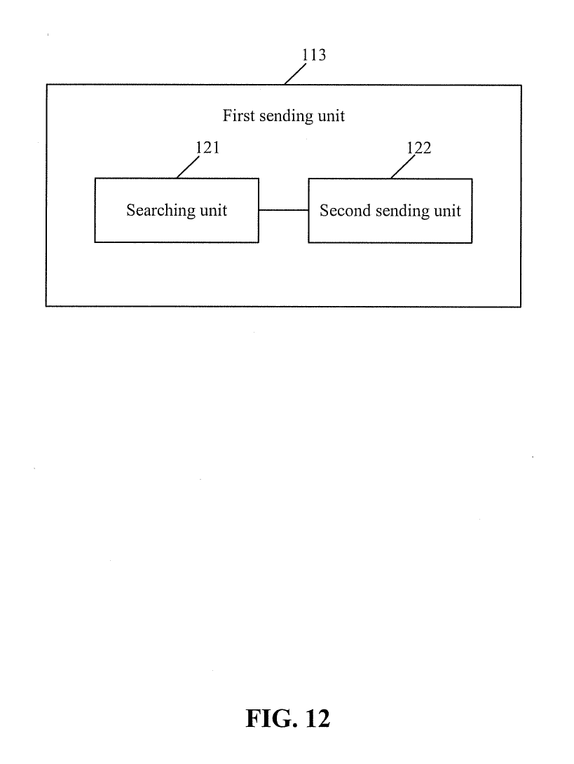

The target data packet includes a target domain name. As shown in FIG. 12, first sending unit 113 can further includes: a searching unit 121 and a second sending unit 122.

Searching unit 121 can be configured to search for a target IP address corresponding to the target domain name based on a first correspondence between a domain name and an IP address.

Second sending unit 122 can be configured to send the normal packet to a target website server corresponding to the target IP address.

The process of building a correspondence between a target domain name and a target IP address specifically includes: acquiring configuration information sent by the security gateway before the data packet sent by the network device is received, wherein the configuration information includes the target domain name and the target IP address of the target website server; and building the correspondence between the target domain name and the target IP address.

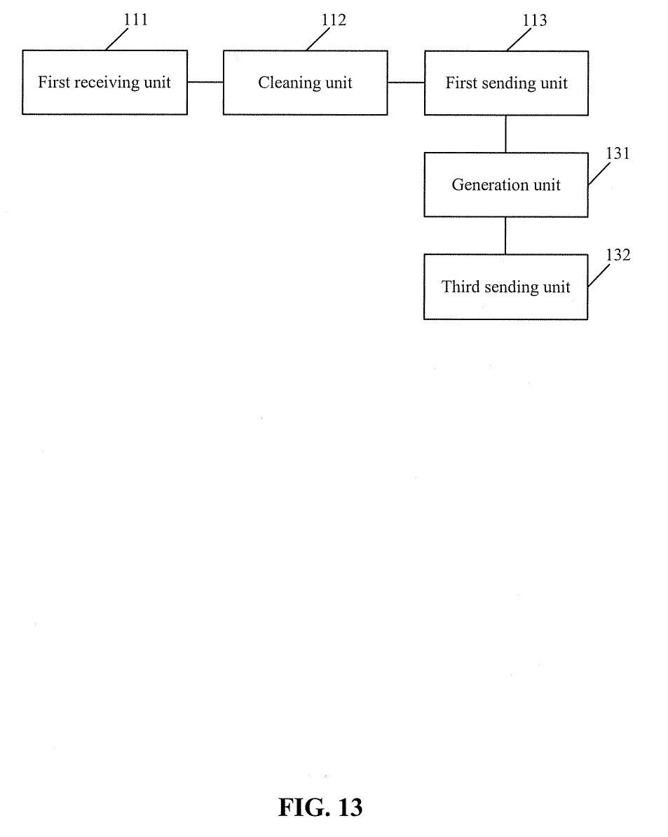

As shown in FIG. 13, the data processing apparatus further includes: a generation unit 131 and a third sending unit 132.

Generation unit 131 can be configured to generate an attack protection log, wherein the protection log includes attack time of attacking packets and a data volume of the attacking packets.

Third sending unit 132 can be configured to send the attack protection log to the security gateway. The attack protection log can be displayed by the security gateway.

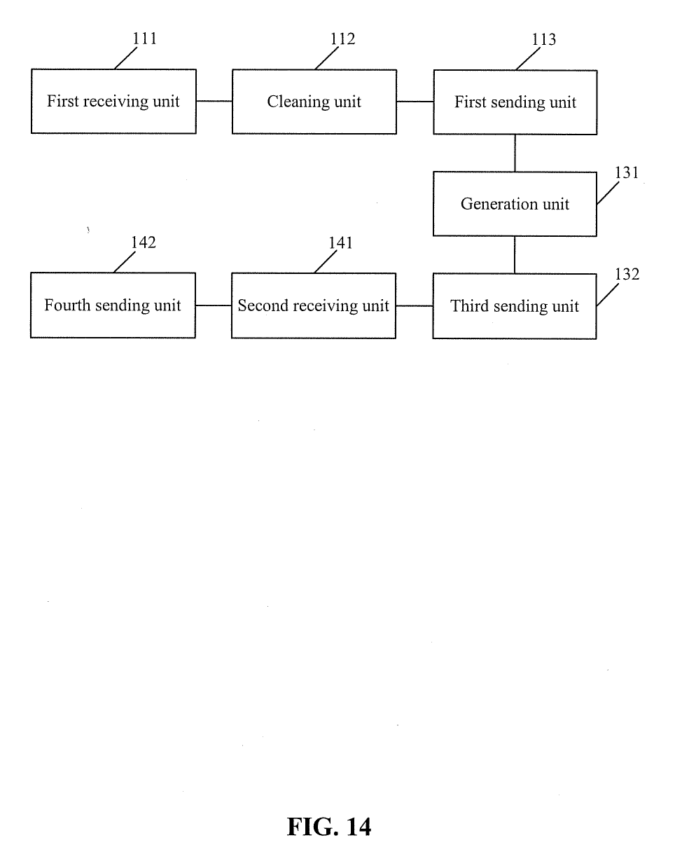

As shown in FIG. 14, the data processing apparatus further includes: a second receiving unit 141 and a fourth sending unit 142.

Second receiving unit 141 can be configured to receive a feedback packet including a terminal IP address and sent by the target website server, wherein the feedback packet is obtained after the target website server processes the data packet.

Fourth sending unit 142 can be configured to send the feedback packet to the network device, wherein the network device sends the feedback packet to the terminal based on the terminal IP address.

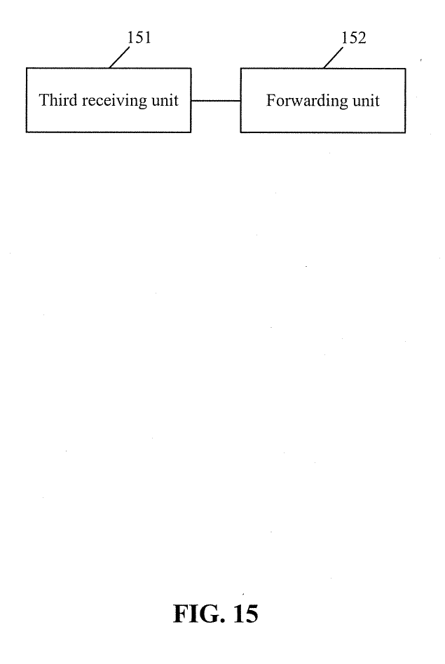

As shown in FIG. 15, embodiments of the present application further provide a data processing apparatus, which can be applied to a network device of a data processing system. The apparatus can include: a third receiving unit 151 and a forwarding unit 152.

Third receiving unit 151 can be configured to receive a target data packet sent by a terminal.

Forwarding unit 152 can be configured to forward the target data packet to a cleaning system, wherein the target data packet sent by the network device is received and the target data packet includes a target domain name; clean the target data packet; and send a normal packet after the cleaning to a target website server provided with a security gateway.

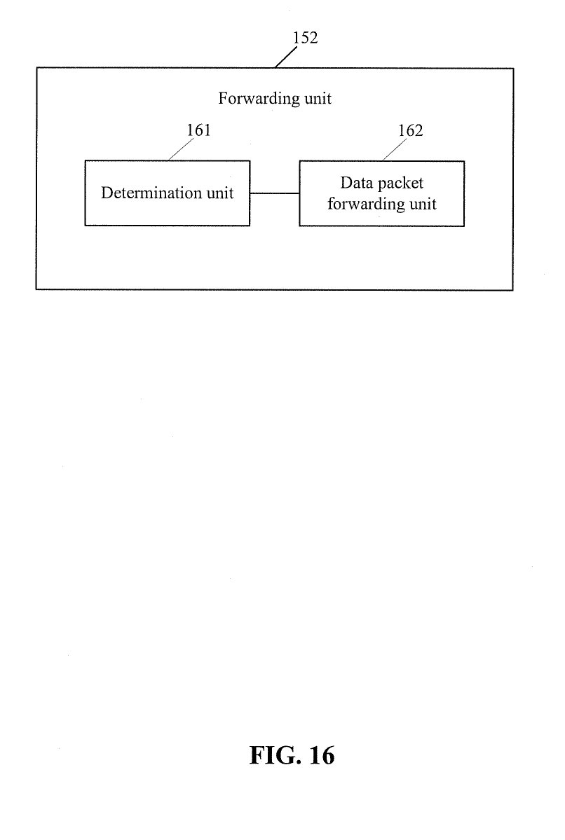

As shown in FIG. 16, forwarding unit 152 can further include: a determination unit 161 and a data packet forwarding unit 162.

Determination unit 161 can be configured to determine a cleaning IP address corresponding to the target domain name based on a second correspondence between a domain name and an IP address, wherein the network device stores a correspondence between the target domain name and the cleaning IP address, and the cleaning IP address is an IP address of a target cleaning device in the cleaning system.

Data packet forwarding unit 162 can be configured to forward the data packet to a target cleaning device corresponding to the cleaning IP address.

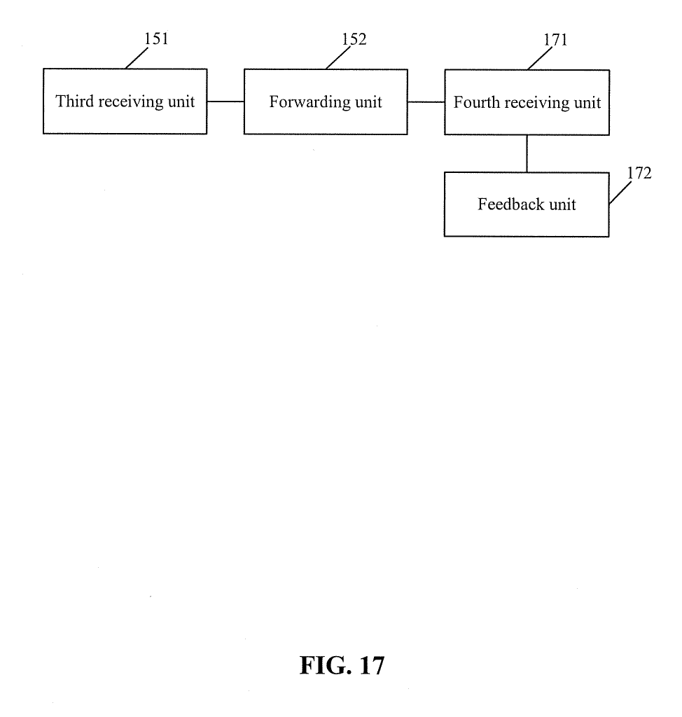

As shown in FIG. 17, the data processing apparatus further includes: a fourth receiving unit 171 and a feedback unit 172.

Fourth receiving unit 171 can be configured to receive a feedback packet including a terminal IP address and sent by the cleaning system, wherein the feedback packet is obtained after the website server processes the data packet, and the feedback packet is sent to the cleaning system through the security gateway.

Feedback unit 172 can be configured to send the feedback packet to the terminal based on the terminal IP address.

The function described in the method of embodiments of the application, if implemented in a form of a software functional unit and sold or used as an independent product, may be stored in a computer readable storage medium. Based on such an understanding, a part of the technical solution may be implemented in the form of a software product. The software product may be stored in a storage medium and includes several instructions for instructing a computing device (which may be a personal computer, a server, a mobile computing device, or a network device) to execute all or part of the steps in the methods described in the embodiments of the present application. The storage medium includes: a USB flash disk, a mobile hard disk, a Read-Only Memory (ROM), a Random Access Memory (RAM), a magnetic disk, an optical disc, or other media that can store program codes.

Embodiments of the application are described in a progressive manner, each embodiment emphasizes a difference between it and other embodiments, and identical or similar parts in the embodiments may be obtained with reference to each other.

The foregoing illustration of the disclosed embodiments enables those skilled in the art to implement or use the present application. Various modifications on the embodiments are obvious for those skilled in the art, and general principles defined in this text may be implemented in other embodiments without departing from the spirit or scope of the present application. Therefore, the present application is not limited by the embodiments shown in this text but conforms to the widest range consistent with the principle and innovative features disclosed in this text.

1. A data processing method, comprising:
receiving a target data packet sent by a network device;
cleaning the target data packet; and
sending the cleaned target data packet to a target website server.

2. The method according to claim 1, wherein the target data packet comprises a target domain name, and sending the cleaned target data packet further comprises:
determining a target IP address associated with the target domain name; and
sending the cleaned target data packet to the target website server corresponding to the target IP address.

3. The method according to claim 2, further comprising:
acquiring configuration information from a security gateway of the target website server, wherein the configuration information comprises the target domain name and the target IP address of the target website server.

4. The method according to claim 3, further comprising:
generating an attack protection log based on the cleaning of the target data packet; and
sending the attack protection log to the security gateway.

5. The method according to claim 1, further comprising:
receiving, from the target website server, a feedback packet including a terminal IP address, wherein the feedback packet is obtained after the target website server processes the cleaned target data packet; and
sending the feedback packet to the network device.

6-8. (canceled)

9. A data processing apparatus, comprising:
a communication interface;
a memory storing a set of instructions; and
at least one processor configured to execute the set of instructions to cause the apparatus to perform:
receiving a target data packet sent by a network device;
cleaning the target data packet; and
sending the cleaned target data packet to a target website server.

10. The apparatus according to claim 9, wherein the target data packet comprises a target domain name, and sending the cleaned target data packet further comprises:
determining a target IP address associated with the target domain name; and
sending the cleaned target data packet to the target website server corresponding to the target IP address.

11. The apparatus according to claim 10, wherein the at least one processor is configured to further execute the set of instructions to cause the apparatus to perfoim:
acquiring configuration information from a security gateway of the target website server, wherein the configuration information comprises the target domain name and the target IP address of the target website server.

12. The apparatus according to claim 11, wherein the at least one processor is configured to further execute the set of instructions to cause the apparatus to perform:
generating an attack protection log based on the cleaning of the target data packet; and
sending the attack protection log to the security gateway.

13. The apparatus according to claim 9, wherein the at least one processor is configured to further execute the set of instructions to cause the apparatus to perform:
receiving, from the target website server, a feedback packet including a terminal IP address, wherein the feedback packet is obtained after the target website server processes the cleaned target data packet; and
sending the feedback packet to the network device.

14-16. (canceled)

17. A non-transitory computer-readable storage medium storing a set of instructions that is executable by one or more processors of an electronic device to cause the electronic device to perform a data processing method, the method comprising:
receiving a target data packet sent by a network device;
cleaning the target data packet; and
sending the cleaned target data packet to a target website server.

18. The non-transitory computer-readable storage medium according to claim 17, wherein the target data packet comprises a target domain name, and the set of instructions is executable to further cause the electronic device to perform:
determining a target IP address associated with the target domain name; and
sending the cleaned target data packet to the target website server corresponding to the target IP address.

19. The non-transitory computer-readable storage medium according to claim 18, wherein the set of instructions is executable to further cause the electronic device to perform:
acquiring configuration information from a security gateway of the target website server, wherein the configuration information comprises the target domain name and the target IP address of the target website server.

20. The non-transitory computer-readable storage medium according to claim 19, wherein the set of instructions is executable to further cause the electronic device to perform:
generating an attack protection log based on the cleaning of the target data packet; and
sending the attack protection log to the security gateway.

21. The non-transitory computer-readable storage medium according to claim 17, wherein the set of instructions is executable to further cause the electronic device to perform:
receiving, from the target website server, a feedback packet including a terminal IP address, wherein the feedback packet is obtained after the target website server processes the cleaned target data packet; and
sending the feedback packet to the network device.

22-24. (canceled)
